(19) United States
(12) Patent Application Publication
(10) Pub. No.: US 2026/0135674 A1
(43) Pub. Date: May 14, 2026

(54) Transmitter Quality Metric for a standalone estimate of Coherent Optical Transmitter Performance

(71) Applicant: Ciena Corporation, Hanover, MD (US)

(72) Inventors: Lukas Jakober, Ottawa (CA); Eric Maniloff, Woodlawn (CA); Riyaz Jamal, Waterloo (CA); Andrzej Borowiec, Ottawa (CA); Ian Betty, Ottawa (CA)

(73) Assignee: Ciena Corporation, Hanover, MD (US)

(21) Appl. No.: 18/944,101

(22) Filed: Nov. 12, 2024

(51) Int. Cl. H04L 5/00; H04L 1/20

(52) U.S. Cl. CPC H04L 5/006; H04L 1/203

(57) ABSTRACT

Systems and methods for a transmitter quality metric (TQM) for a standalone estimate of coherent optical transmitter performance include, responsive to defining a reference receiver having known parameters, conducting noise loading on an output signal from a transmitter under test; utilizing the reference receiver and a calculation to determine a transmitter only required signal-to-noise ratio (RSNR) penalty, ΔRSNRₜₓ; and providing the ΔRSNRₜₓ as a transmitter quality metric (TQM). The transmitter only RSNR penalty is a difference between a RSNR to achieve a required pre-forward error correction (FEC) bit error rate (BER) and a theoretically required RSNR for an ideal modem.

### FIELD OF THE DISCLOSURE

The present disclosure relates generally to fiber optics. More particularly, the present disclosure relates to systems and methods for a transmitter quality metric (TQM) for a standalone estimate of coherent optical transmitter performance.

### BACKGROUND OF THE DISCLOSURE

Generally, a transmitter quality metric is a measure used to evaluate the performance and accuracy of a coherent optical transmitter. Example metrics include (1) error vector magnitude (EVM), which measures deviation from ideal signal points, (2) modulation error ratio (MER) which also evaluates modulation precision, especially in higher order formats like n-ary (n≥4) quadrature amplitude modulation (n-QAM), (3) optical signal-to-noise ratio (OSNR), which compares optical signal power to ASE noise power, (4) Frequency Offset, which assesses any frequency shift relative to a reference that could degrade signal quality at the receiver, and (5) Phase Noise, which measures the stability of the transmitter's carrier phase, crucial for maintaining clean signal points in sensitive modulations. Transmitter quality metrics play a crucial role in distinguishing transmitter-originated noise and distortion from issues arising within the optical link itself. These metrics enable attribution of performance issues accurately and are also used to verify compliance with standards. Compliance with these standards is critical for interoperability. Conventional approaches to measuring transmitter performance are inaccurate and misleading because they fail to differentiate between noise and distortion, thus misrepresenting the true nature of the signal impairments. They oversimplify the impairment model by assuming only additive white Gaussian noise (AWGN), which fails to capture the complexities of real-world transmitters. Furthermore, these approaches are hampered by their complexity, often requiring time-consuming iterations or depending on poorly defined reference receiver models.

### BRIEF SUMMARY OF THE DISCLOSURE

The present disclosure relates to systems and methods for a transmitter quality metric (TQM) for a standalone estimate of coherent optical transmitter performance. The present disclosure introduces a methodology to estimate a standalone transmitter (Tx) quality metric (TQM). The proposed TQM, ΔRSNRₜₓ, measures the performance penalty caused by the transmitter, expressed in dB, relative to an ideal transmitter paired with a reference receiver (Rx). Defining TQM as a performance penalty rather than a strict Tx signal quality metric has a key advantage: a penalty-based metric correlates more accurately with real-world performance as measured through typical hardware receivers. Strict signal quality metrics, such as Tx EVM, fall short in differentiating between Tx noise and Tx distortion. Some types of Tx distortion can be compensated for by a well-designed receiver, so they need to be considered in the TQM calculation to avoid underestimating transmitter quality. Conversely, non-AWGN (additive white Gaussian noise) Tx noise sources might lead to an overestimated TQM.

A penalty-based transmitter quality metric (TQM) directly provides insights into the impact of the measured transmitter (Tx) on overall system performance, eliminating the need for further processing. This approach allows for a straightforward, accurate assessment of how Tx quality affects the system. Additionally, using a two-parameter fit to evaluate the performance metric is simple, numerically robust, and efficient, providing fast and reliable results for performance evaluation.

In an embodiment, a method includes, responsive to defining a reference receiver having known parameters, conducting noise loading on an output signal from a transmitter under test; utilizing the reference receiver and a calculation to determine a transmitter only required signal-to-noise ratio (RSNR) penalty, ΔRSNRₜₓ; and providing the ΔRSNRₜₓ as a transmitter quality metric (TQM). The transmitter only RSNR penalty is a difference between a RSNR to achieve a required pre-forward error correction (FEC) bit error rate (BER) and a theoretically required RSNR for an ideal modem in Decibel (dB). The difference is due to imperfections in the transmitter under test where the imperfections are due to noise and/or eye closure. The utilizing can include use of the reference Rx to measure BER. The BER is converted to ENSR to perform a curve fit between NSRₐₛₑ and ENSR. The utilizing can determine modem eye closure (EC_{modem}) and Modem implementation noise-to-signal ratio (NSR_{modem}).

The utilizing can include determining the RSNR penalty between both the transmitter under test and the reference receiver and extracting the transmitter only RSNR penalty by removing contributions from the reference receiver using the known parameters. The conducting noise loading can include virtually adding additive white Gaussian noise (AWGN) to the output signal. The reference receiver can be one of a plurality of reference receivers, each having different capabilities or designs, and the method can further include performing the utilizing and the providing for each of the plurality of reference receivers, such that the TQM is provided for each of the plurality of reference receivers. The method can further include utilizing the TQM to determine whether or not the transmitter under test complies with a specification or standard. The method can further include analyzing quality of an operating link with the transmitter under test and utilizing the TQM to determine any imperfections on the operating link due to the transmitter under test.

In another embodiment, a system includes circuitry configured to, responsive to defining a reference receiver having known parameters, conduct noise loading on an output signal from a transmitter under test, utilize the reference receiver and a calculation to determine a transmitter only required signal-to-noise ratio (RSNR) penalty, ΔRSNRₜₓ, and provide the ΔRSNRₜₓ as a transmitter quality metric (TQM). The transmitter only RSNR penalty is a difference between a RSNR to achieve a required pre-forward error correction (FEC) bit error rate (BER) and a theoretically required RSNR for an ideal modem in dB. The difference is due to imperfections in the transmitter under test where the imperfections are due to noise and/or modem eye closure. The reference receiver can be utilized to determine modem eye closure (EC_{modem}) and Modem implementation noise-to-signal ratio (NSR_{modem}).

The transmitter only RSNR penalty can be extracted by determining the RSNR penalty between both the transmitter under test and the reference receiver and extracting the transmitter only RSNR penalty by removing contributions from the reference receiver using the known parameters. The noise loading can include virtually adding additive white Gaussian noise (AWGN) to the output signal. The reference receiver can be one of a plurality of reference receivers, each having different capabilities or designs, and wherein the circuitry is further configured to utilize each of the plurality of reference receivers, such that the TQM is provided for each of the plurality of reference receivers. The circuitry can be further configured to utilize the TQM to determine whether or not the transmitter under test complies with a specification or standard. The circuitry can be further configured to analyze quality of an operating link with the transmitter under test and utilizing the TQM to determine any imperfections on the operating link due to the transmitter under test.

### BRIEF DESCRIPTION OF THE DRAWINGS

The present disclosure is detailed through various drawings, where like components or steps are indicated by identical reference numbers for clarity and consistency.

FIG. 1 illustrates a diagram of a system with a transmitter connected to a receiver, via a fiber, with amplified spontaneous emission (ASE) noise.

FIG. 2 illustrates a mathematical model of the system of FIG. 1.

FIG. 3 illustrates a graph of electrical signal-to-noise ratio (ESNR) versus BER for n-QAM constellations.

FIG. 4 illustrates graphs providing a pictorial representation of the data collection and parameter extraction steps during the ASE noise loading experiment.

FIG. 5 illustrates a graph of BER vs. SNRₐₛₑ curves for 16-QAM at various SNR_{modem} (dB).

FIG. 6 illustrates a measurement configuration using a reference Rx.

FIG. 7 illustrates a flowchart of a process for a transmitter quality metric (TQM) for a standalone estimate of coherent optical transmitter performance.

### DETAILED DESCRIPTION OF THE DISCLOSURE

Again, the present disclosure relates to systems and methods for a transmitter quality metric (TQM) for a standalone estimate of coherent optical transmitter performance. Specifically, the TQM described herein is a normative measure of transmitter induced performance penalty in dB relative to an ideal transmitter. The TQM is a Tx only required signal-to-noise ratio (RSNR) penalty determined using a captured device under test (DUT) Tx output waveform and a reference receiver. RSNR Penalty refers to the degradation in received signal quality (measured by the signal-to-noise ratio) compared to an ideal scenario, due to imperfections in the transmitter (Tx). This penalty quantifies how much the performance is impacted by factors such as transmitter noise or distortion, providing a useful metric for assessing transmitter quality relative to an ideal signal condition.

The present disclosure systematically develops a more comprehensive TQM applicable to n-QAM constellations, including dual polarization 16-QAM (DP-16QAM), and shows how the proposed TQM reduces to transmitter constellation closure (TCC). The proposed TQM should thus be considered in the same family as TCC, providing potentially greater accuracy and simpler processing.

The TQM is not intended as a replacement for individual Tx parametric specifications for easily describable modulation impairments since these allow for specification of the required tolerance of the Rx to the same impairments. On the contrary, the TQM is intended to bound the overall transmit performance. Allowing all Tx parameters to be at their worst-case values in specifying a worst-case Tx would be unrealistic and prohibitive as part of a Rx OSNR tolerance requirement. A compliant Tx would require meeting both individual parametric and TQM specifications.

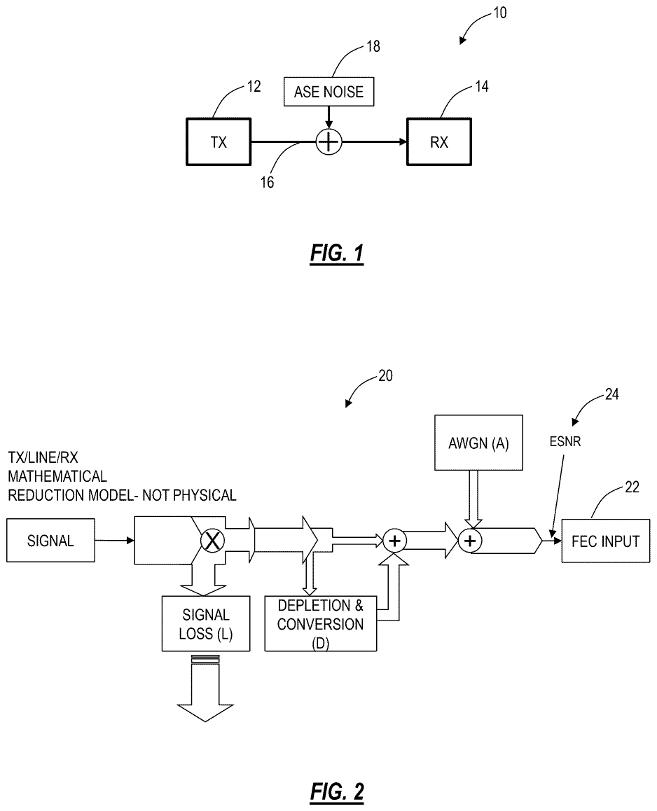

FIG. 1 illustrates a diagram of a system 10 with a transmitter 12 connected to a receiver 14, via a fiber 16, with amplified spontaneous emission (ASE) noise 18. FIG. 2 illustrates a mathematical model 20 of the system 10. The transmitter 12 is a coherent optical transmitter and can use n-QAM, DP-n-QAM, etc., to support 400 Gb/s up to 1.6 Tb/s and beyond. The system 10 illustrates a single direction from the transmitter 12 to the receiver 14 over the fiber 16, for unidirectional communication. Of course, a practical embodiment would include another set of equipment in the opposite direction for bidirectional communication. Generally, the transmitter 12 and a corresponding receiver in the another set of equipment are housed in an optical module. The optical module can be specified by a standard, specification, multisource agreement (MSA), etc. Those skilled in the art will recognize terminology for the transmitter and receiver pair in the optical module can include a transceiver, transponder, modem, etc. The present disclosure focuses on an approach to measure and characterize the transmitter 12 quality.

In some embodiments, the optical module can be a pluggable optical module Pluggable optical modules are compact, hot-swappable devices that provide optical transceivers for use in switches, routers, servers, etc. These modules convert electrical signals to optical signals and vice versa, facilitating data communication over distances ranging from a few meters to several kilometers or even longer. Examples of common types of pluggable modules include Quad Small Form-factor Pluggable (QSFP), C Form-factor Pluggable (CFP), Octal Small Form-factor Pluggable (OFP), and variants thereof. Of course, other types of optical modules are also contemplated—the TQM described herein is not limited to pluggable optical modules.

In some embodiments, the TQM described herein contemplates standardization between vendors, so that there is a common reference for measuring quality. For example, the Optical Internetworking Forum (OIF) 400ZR and 800ZR are standardized specifications designed for high-speed, coherent optical modules. Both target data center interconnect (DCI) applications, enabling efficient and cost-effective data transmission over metro distances of up to 80 kilometers. 400ZR supports 400 Gb/s links, using pluggable modules like QSFP-DD and OSFP, which are compatible with common data center switches and routers. This standard was developed to simplify data center connectivity, providing an interoperable, low-latency solution without the need for complex, long-haul transmission equipment. Building on the 400ZR standard, 800ZR aims to double the data rate to 800 Gb/s catering to growing bandwidth demands in data centers and higher-capacity network architectures. For example, the TQM could be specified in these specifications.

For a basic modem Tx-to-Rx fiber connection over a patch-cord with optional ASE noise loading, as shown in the system 10 in FIG. 1, the signal-to-noise ratio at a forward error correction (FEC) input 22, at the receiver 14, electrical signal-to-noise ratio (ESNR) 24, may be described assuming a noise model which includes signal loss/conversion ahead of the noise addition,

$$E S N R = \frac{E {C}_{m o d e m}^{- 1} \cdot S}{{N}_{a s e} + {N}_{m o d e m}} = \frac{E {C}_{m o d e m}^{- 1}}{N S {R}_{a s e} + N S {R}_{m o d e m}} \qquad ( 1 )$$

where the following definitions apply
EC_{modem}: Eye-closure term, representing signal loss
S: Signal power
Nₐₛₑ: ASE noise power
N_{modem}: Modem implementation noise power
NSRₐₛₑ: ASE noise-to-signal ratio
NSR_{modem}: Modem implementation noise-to-signal ratio

The ENSR 24 measures the ratio of signal power to noise power in the electrical domain, typically after the optical signal has been converted to an electrical signal at the receiver. ESNR is used to assess the quality and clarity of the received signal, helping to determine how much noise is present relative to the signal. This metric is particularly important in coherent optical systems, where high ESNR values indicate better signal integrity, enabling more accurate data recovery and higher performance in the system 10.

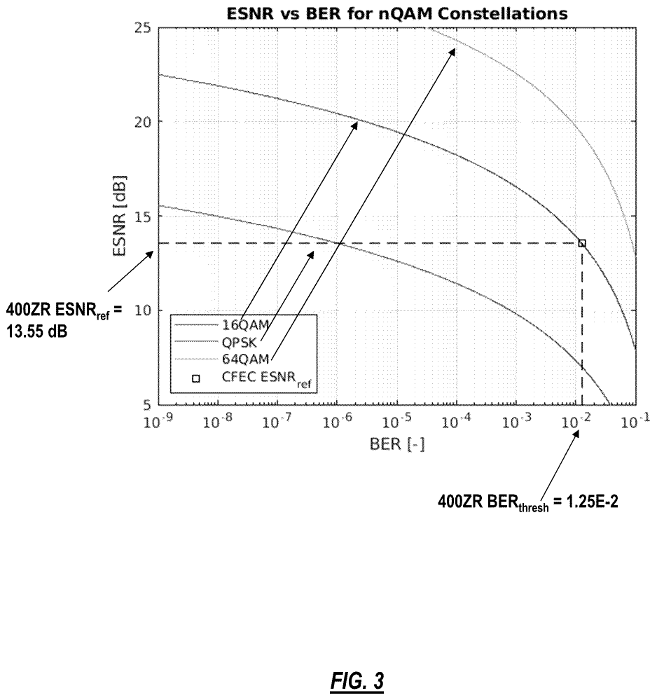

The noise tolerance of the system 10 is determined by the minimum required 24 ESNR at the FEC input 22, ESNR_{ref}. Under AWGN conditions, ESNR_{ref} is only a function of the modulation format and the maximum bit error rate (BER) tolerated by the FEC. FIG. 3 illustrates a graph of ESNR versus BER for n-QAM constellations. For example, concatenated FEC (CFEC) in 400ZR and 800ZR has a 1.25E-2 BER FEC threshold, and RS+BCH has a 1.1E-2 BER FEC threshold. RS+BCH refers to a concatenated error correction scheme that combines Reed-Solomon (RS) coding with Bose-Chaudhuri-Hocquenghem (BCH) coding.

The optical SNRₐₛₑ at the modem input (receiver 14) is defined as:

$${SNR}_{ase} = \frac{S}{{N}_{ase}} = \frac{1}{{NSR}_{ase}} \qquad ( 2 )$$

Furthermore, the performance of an implementation can be characterized by its Required SNRₐₛₑ (RSNRₐₛₑ) at the modem input.

$${RSNR}_{ase} = \frac{S}{{\overline{N}}_{ase}} = \frac{1}{{\overline{NSR}}_{ase}} \qquad ( 3 )$$

where the following definitions apply
N̅ₐₛₑ: Maximum ASE noise that can be added before the BER FEC threshold is reached.
N̅S̅R̅ₐₛₑ: Maximum ASE noise-to-signal ratio

RSNRₐₛₑ may be measured or can be calculated analytically based on ESNR_{ref}. Using equation (1) and re-arranging:

$${ESNR}_{ref} = \frac{{EC}_{modem}^{- 1}}{{\overline{NSR}}_{ase} + {NSR}_{modem}} \qquad ( 4 )$$

$${\overline{NSR}}_{ase} = {( {EC}_{modem} \cdot {ESNR}_{ref} )}^{- 1} - {NSR}_{modem}$$

$${RSNR}_{ase} = {( {( {EC}_{modem} \cdot {ESNR}_{ref} )}^{- 1} - {NSR}_{modem} )}^{- 1}$$

The theoretical RSNR, RSNRₜₕ, is defined for an ideal modem (NSR_{modem}=0 and EC_{modem}=1), and is equal to the reference, ESNR_{ref}:

$${RSNR}_{th} {=}^{def} {( {( 1 \cdot {ESNR}_{ref} )}^{- 1} - 0 )}^{- 1} = {ESNR}_{ref} \qquad ( 5 )$$

For typical modem implementations, RSNRₐₛₑ>RSNRₜₕ. Thus, the quality of a modem may be quantified by the RSNR penalty, ΔRSNR_{modem}, due to modem implementation noise and modem eye-closure:

$$Δ {RSNR}_{modem} = {RSNR}_{ase} ( {EC}_{modem} , {NSR}_{modem} ) / {RSNR}_{th} \qquad ( 6 )$$

The analytical calculation of RSNRₐₛₑ is only feasible if the modem eye-closure (EC_{modem}) and implementation noise (NSR_{modem}) are known. These values can be estimated via a noise loading experiment.

The noise loading experiment leverages the previously defined relationship in equation (1) between ESNR and NSRₐₛₑ, rewritten in equation (7) to support a first-order Minimum Mean Squared Error (MMSE) fit.

$$ESNR = \frac{{EC}_{modem}^{- 1}}{{NSR}_{ase} + {NSR}_{modem}} \qquad ( 7 )$$

$$ESNR = \frac{1}{{EC}_{modem} ( {NSR}_{ase} + {NSR}_{modem} )}$$

$$ENSR = {EC}_{modem} ( {NSR}_{ase} + {NSR}_{modem} )$$

$$ENSR = {EC}_{modem} {NSR}_{ase} + {EC}_{modem} {NSR}_{modem}$$

$$ENSR = a \cdot {NSR}_{ase} + b where$$

$$ENSR = \frac{1}{ESNR}$$

The coefficients a and b are then used to obtain the estimates:

$${modem}_{} = a and {modem}_{} = b / {modem}_{}$$

The coefficients a and b are the parameters of the linear fit-they are directly related to the Implementation Noise (IMN) and Eye Closure (EC) values.

The experiment is conducted as follows:
(1) For each step, increment the ASE noise level at the modem input in steps and measure SNRₐₛₑ as well as its corresponding BER at the FEC input.

$$\{ {SNR}_{ase}^{( 1 )} , {SNR}_{ase}^{( 2 )} , … , {SNR}_{ase}^{( N )} \} ⟷ \{ {BER}^{( 1 )} , {BER}^{( 2 )} , … , {BER}^{( N )} \}$$

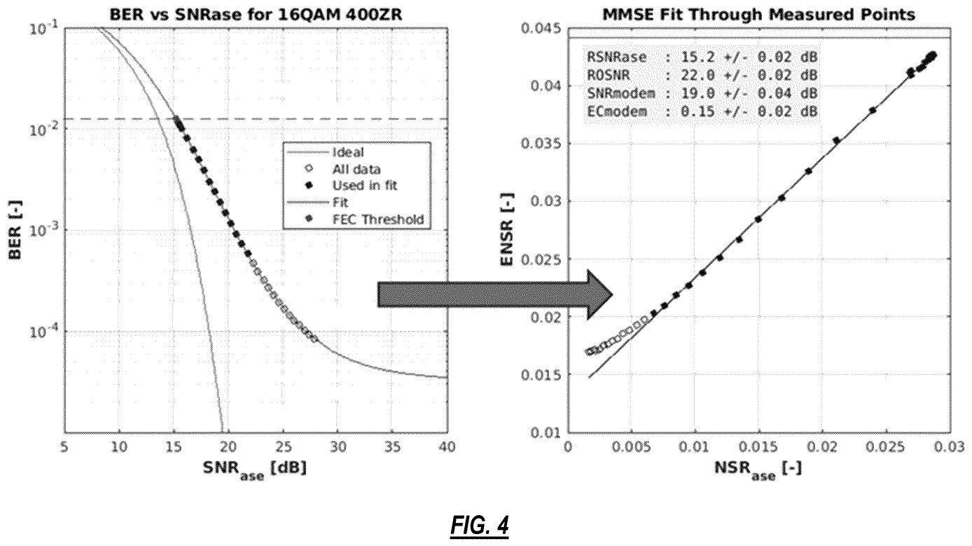

(2) Use the known ESNR(BER) relationship, e.g., an example is shown in FIG. 3, and calculate all ENSR⁽ⁿ⁾ and NSRₐₛₑ⁽ⁿ⁾ points.
(3) Calculate the 1^{st} order MMSE fit (slope a and offset b) in the vicinity of the FEC threshold over the range where the measured ENSR vs. NSRₐₛₑ relationship is linear, as shown in FIG. 4, right-hand plot. Then, using equation (7),

$${modem}_{} = a \qquad ( 8 )$$

$${modem}_{} = b / {modem}_{}$$

(4) The estimated RSNRₐₛₑ and the ΔRSNR_{modem} may be calculated as follows:

$${ase}_{} = {( {( {modem}_{} \cdot {ESNR}_{ref} )}^{- 1} - {modem}_{} )}^{- 1} \qquad ( 9 )$$

$$Δ {RSNR}_{modem} = {ase}_{} / {RSNR}_{th}$$

FIG. 4 illustrates graphs providing a pictorial representation of the data collection and parameter extraction steps during the ASE noise loading experiment. It should be noted that the 2-parameter fit does not require the use of a noise search algorithm.

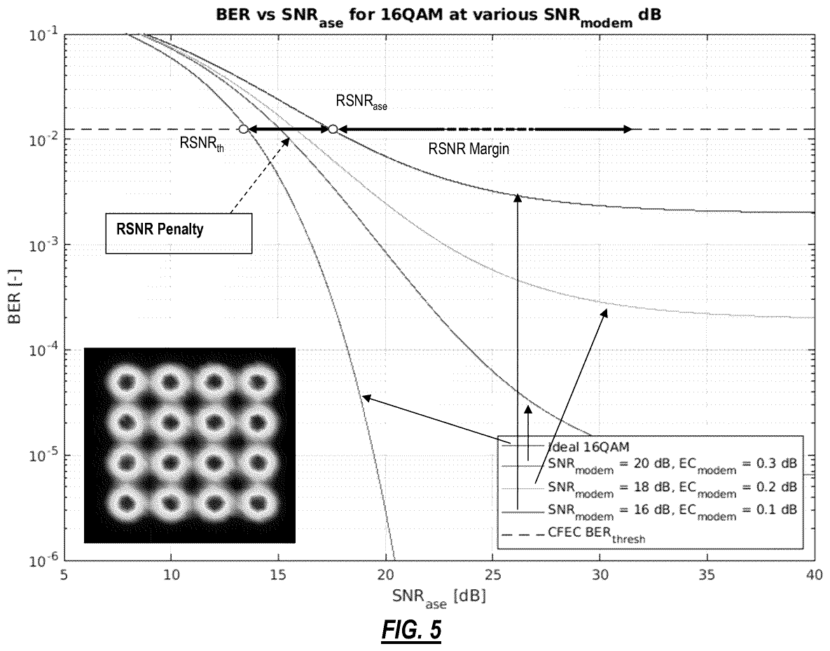

FIG. 5 illustrates a graph of BER vs. SNRₐₛₑ curves for 16-QAM at various SNR_{modem} (dB). Using these curves, the following are defined:
RSNRₐₛₑ: Required signal-to-noise ratio to achieve the required pre-FEC Frame Error Ratio.
RSNRₜₕ: Theoretically required signal-to-noise ratio given an ideal modem.
RSNR Penalty: Difference between RSNRₐₛₑ and RSNRₜₕ in dB.
RSNR Margin: Difference between the actual SNRₐₛₑ and RSNR in dB

The combined modem implementation penalty so far defined as NSR_{modem} and EC_{modem}, is a function of Tx and Rx implementations,

$${NSR}_{modem} = {NSR}_{tx} + {NSR}_{rx} \qquad ( 10 )$$

$${EC}_{modem} = {EC}_{tx} \cdot {EC}_{rx}$$

### REFERENCE RX

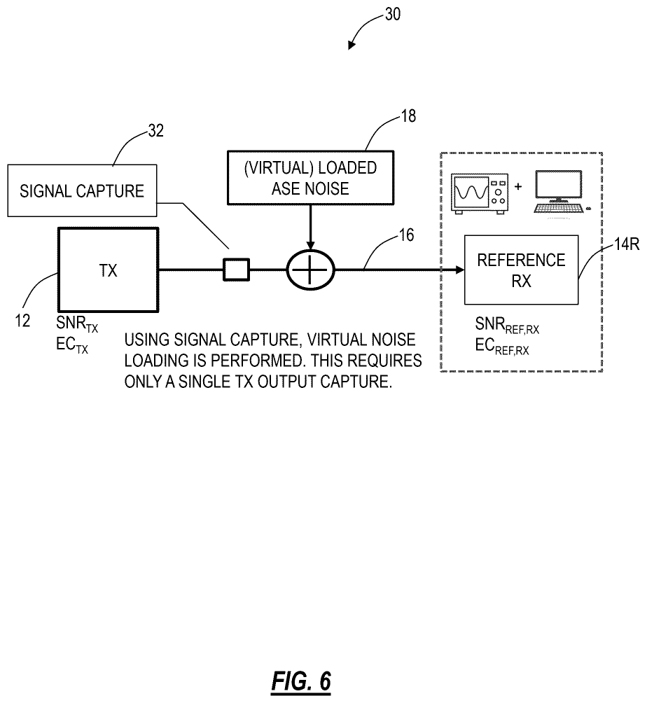

For evaluating a Tx-only RSNR penalty TQM, a measurement using a Reference Rx is required. FIG. 6 illustrates a measurement configuration in a system 30 using a reference Rx 14R. As described herein, the reference Rx 14R is one having known parameters so that it is possible to remove the receiver contributions to the penalty to achieve the Tx-only RSNR penalty TQM. That is, the foregoing descriptions and computations detailed the RSNR penalty TQM for the entire system 10, and using known values for the Rx-only RSNR penalty with the reference Rx 14R enables a determination of the Tx-only RSNR penalty TQM. This can be performed in the system 30 where a Tx 14 has its output signal captured (signal capture 32), virtual loaded ASE noise 18 is added thereto and processed by the reference Rx 14R,

Two classes of the reference Rx 14R can be considered:
(1) Type 1—Golden Rx: Unrealistic complexity, able to fully-compensate Tx impairments.
(2) Type 2—Typical Rx: Representative of a typical Rx performance.

For a TQM implementation intended to bound the overall Tx performance, a Type 2 reference Rx is required. Here, the reference Rx should exhibit the following characteristics:
(1) Must provide realistic compensation of Tx distortion versus Tx noise.
(2) Must have appropriate Rx clock recovery and carrier recovery bandwidths according to Rx specifications.
(3) Optical-electrical (OE) front-end, typically part of test instrumentation, must be characterized and its implementation penalty (SNR_{ref,rx}, EC_{ref,rx}) must be calibrated.

Applying the analysis methodology developed previously in equation (10) on the collected data from the reference Rx measurement, we can extract:

$${NSR}_{tx} = {modem}_{} - {NSR}_{ref , rx} \qquad ( 11 )$$

$${EC}_{tx} = \frac{{modem}_{}}{{EC}_{ref , rx}}$$

Note that NSRₜₓ and NSR_{ref,rx} are often defined in terms of their inverse, SNRₜₓ and SNR_{ref,rx}, respectively, to produce a positive value in dB. Based on the Tx implementation noise, Tx eye closure, and the reference Rx 14R calibration data, the Tx only RSNR penalty, ΔRSNRₜₓ, can thus be calculated:

$${RSNR}_{vase} = {( {( {EC}_{tx} \cdot {ESNR}_{ref} )}^{- 1} - {NSR}_{tx} )}^{- 1} \qquad ( 12 )$$

$$Δ {RSNR}_{tx} = {RSNR}_{vase} / {RSNR}_{th}$$

In the system 30, the described noise loading experiment does not have to be conducted using real ASE noise. Alternatively, a Tx signal waveform can be captured without noise loading and AWGN can be added virtually to simulate ASE noise. The measurement process is equivalent, but instead of measuring SNRₐₛₑ and its corresponding BER at the FEC input, the virtual noise power, NSRᵥ₋ₐₛₑ, is determined directly and the BER is estimated using the same reference Rx 14R

$$\{ {NSR}_{v - ase}^{( 1 )} , {NSR}_{v - ase}^{( 2 )} , … , {NSR}_{v - ase}^{( N )} \} ⟷ \{ {BER}^{( 1 )} , {BER}^{( 2 )} , … , {BER}^{( N )} \}$$

Using offline processing to implement a reference Rx 14R provides the possibility to have multiple sets of Tx parameters returned based on the capabilities implemented in the receiver. In this manner it is possible to specify multiple allowed ΔRSNRₜₓ values based on different Rx designs.

Tx-Only RSNR Penalty Vs. TCC

Transmitter Constellation Closure (TCC) is useful for assessing transmitter quality but has several limitations: (1) It depends on a one parameter (σ_{TUT}²) fit to evaluate the Tx performance (2) It depends on an iterative search algorithm to find the additive white Gaussian noise (AWGN) power which results in the reference BER_{ref} at the FEC input. This search can be inefficient and time-consuming. (2) The virtual AWGN is added after the captured signal has been low pass filtered (LPF), causing a performance bias compared to optical ASE noise.

Tx-Only RSNR Penalty Vs. Other Metrics

Using SNR-like transmitter quality metrics, such as Transmitter Error Vector Magnitude (EVM) and Transmitter Modulation Error Ratio (MER), presents a challenge because these metrics aggregate different forms of signal impairment—namely, transmitter noise and distortion—without distinguishing between them. Essentially, both noise and distortion contribute to errors or deviations from the ideal signal, so when measuring overall “quality” using EVM or MER, the result is a combined effect of these factors rather than isolating each one. In a high-level sense, noise refers to random fluctuations in the signal, often due to thermal or electronic noise within the transmitter components. Distortion, on the other hand, involves systematic errors or predictable deviations, often caused by non-linearities in the transmitter that alter the signal in repeatable ways. Metrics like EVM and MER report on the overall error in the transmitted signal, but they do not inherently tell how much of that error is due to random noise versus structured distortion. This lack of separation can complicate troubleshooting and optimization, as engineers may need to use additional methods or complementary metrics to pinpoint whether improvements should focus on reducing noise or mitigating distortion.

As such, the present disclosure includes
(1) Use of a performance penalty instead of a direct Tx SNR as a Tx quality metric to avoid overestimating TQM.
(2) Use of a reference Rx with representative capabilities to compensate for Tx distortions to avoid underestimating TQM.
(3) Use of a two-parameter fit to estimate ENSR vs NSRₐₛₑ.
(4) Definition of virtual noise loading experiment such that it yields ASE noise loading equivalent TQM estimates.
(5) Determination of both Eye Closure and Implementation noise for a Tx.
(6) Specifying multiple TQM values for different Rx capabilities.

Further, the approach described herein provides an approach for testing the Tx only in the context of a standard or specification. For example, in the ITU-T G.698.2 (November 18), Amplified multichannel dense wavelength division multiplexing applications with single channel optical interfaces, the contents of which are incorporated by reference in their entirety.

No, prior work used SNRₜₓ (or equivalently, NSRₜₓ, the IMN of the Tx) as the metric. RSNRₜₓ (or more precisely its inverse) represents the amount of AWGN that can be added before the Rx reaches the specified BER_{ref} (or equivalently, ESNR_{ref}). An ideal Tx can tolerate the lowest possible RSNRₜₓ, i.e., RSNRₜₕ (theoretical). We define the ratio between the (indirectly) measured- and the theoretical RSNR as the proposed TQM:

$${RSNR}_{vase} = {( {( {EC}_{tx} \cdot {ESNR}_{ref} )}^{- 1} - {NSR}_{tx} )}^{- 1} \qquad ( 12 )$$

$$Δ {RSNR}_{tx} = {RSNR}_{vase} / {RSNR}_{th}$$

Of note, SNRₜₓ simply measures the signal to present noise power of the Tx, independent of whether that noise is AWGN or not. The proposed TQM measures the delta between the AWGN that can be added to the Tx compared to an ideal Tx before the reference Rx reaches a BER_{ref}. The added noise is by definition Gaussian, and hence the same for all measured Tx's. As a result, the proposed TQM correlates much better with the measured performance of a given Tx into a real Rx than the SNRₜₓ derived performance.

Given the Rx-referred definition of the TQM, the disclosure proposes:
(1) A methodology that defines how modem IMN/EC is measured via an MMSE linear fit between NSRₐₛₑ and ENSR or, alternatively, NSRᵥₐₛₑ and ENSR (virtual noise loading).
(2) A way to separate Tx/Rx IMN/EC.
(3) The calculation of RSNRᵥₐₛₑ based on Tx IMN/EC and ESNR_{ref}.

Regarding the reference Rx 14E, the way the reference Rx has been used in previous TQMs (e.g., EVM) is different. Previously, the reference Rx is employed to re-generate the constellation symbols. These Rx symbols are then compared to either the known- or hard-decision estimated Tx symbols to calculate the error vector. EVM is simply the ratio between the power of the error vector (Gaussian or non-Gaussian), and the average symbol power.

### TQM Process

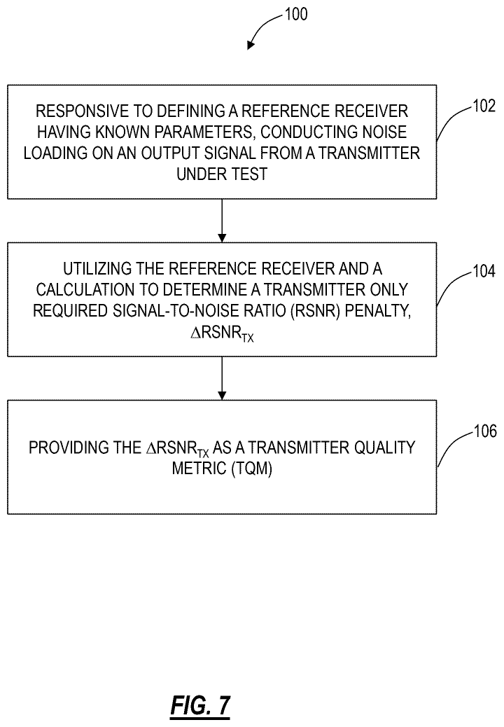

FIG. 7 illustrates a flowchart of a process 100 for a transmitter quality metric (TQM) for a standalone estimate of coherent optical transmitter performance. The process 100 contemplates implementation as a method having steps, via circuitry configured to implement the steps, and as a non-transitory computer-readable medium storing instructions that, when executed, cause one or more processors to implement the steps. The process 100 further contemplates implementation with the systems 10, 30.

The process 100 includes, responsive to defining a reference receiver having known parameters, conducting noise loading on an output signal from a transmitter under test (step 102); utilizing the reference receiver and a calculation to determine a transmitter only required signal-to-noise ratio (RSNR) penalty, ΔRSNRₜₓ (step 104); and providing the ΔRSNRₜₓ as a transmitter quality metric (TQM) (step 106). The reference receiver is used to demodulate the signal and extract a BER, and a set of corresponding Loaded Noise SNR and BER pairs are then used to calculate a linear MMSE fit. The fit parameters (slope and offset) are related to the system (modem) implementation noise and eye closure. After separating Tx and Rx contributions, the Tx only RSNR penalty can be provided as a TQM.

The transmitter only RSNR penalty is a difference between a RSNR to achieve a required pre-forward error correction (FEC) bit error rate (BER) and a theoretically required RSNR for an ideal modem. The difference is due to imperfections in the transmitter under test where the imperfections are due to noise or modem eye closure.

The utilizing determines modem eye closure (EC_{modem}) and Modem implementation noise-to-signal ratio (NSR_{modem}). The utilizing includes use of the reference Rx to calculate BER and to perform a curve fit between NSRₐₛₑ and ENSR. The utilizing includes determining the RSNR penalty between both the transmitter under test and the reference receiver and extracting the transmitter only RSNR penalty by removing contributions from the reference receiver using the known parameters.

The conducting noise loading can include virtually adding additive white Gaussian noise (AWGN) to the output signal. The reference can be one of a plurality of reference receivers, and the process 100 can include performing the utilizing and the providing for each of the plurality of reference receivers in addition to the reference receivers, such that the TQM is provided for each of the plurality of reference receivers each having different capabilities or designs.

The process 100 can include utilizing the TQM to determine whether or not the transmitter under test complies with a specification or standard. The process 100 can include analyzing quality of an operating link with the transmitter under test and utilizing the TQM to determine any imperfections on the operating link due to the transmitter under test. Here, advanced coherent optical modems can be used to assess link quality and knowing the TQM as defined herein allows removal of any Tx imperfections in such assessments.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner-whether collectively, in subsets, or individually-thereby broadening the range of potential embodiments.

What is claimed is:

1. A method comprising steps of:
responsive to defining a reference receiver having known parameters, conducting noise loading on an output signal from a transmitter under test;
utilizing the reference receiver and a calculation to determine a transmitter only required signal-to-noise ratio (RSNR) penalty, ΔRSNRₜₓ; and
providing the ΔRSNRₜₓ as a transmitter quality metric (TQM).

2. The method of claim 1, wherein the transmitter only RSNR penalty is a difference between a RSNR to achieve a required pre-forward error correction (FEC) bit error rate (BER) and a theoretically required RSNR for an ideal modem in Decibel (dB).

3. The method of claim 2, wherein the difference is due to imperfections in the transmitter under test where the imperfections are due to noise and/or eye closure.

4. The method of claim 1, wherein the utilizing includes use of the reference Rx to measure BER.

5. The method of claim 4, wherein the BER is converted to ENSR to perform a curve fit between NSRₐₛₑ and ENSR.

6. The method of claim 1, wherein the utilizing determines modem eye closure (EC_{modem}) and Modem implementation noise-to-signal ratio (NSR_{modem}).

7. The method of claim 1, wherein the utilizing includes determining the RSNR penalty between both the transmitter under test and the reference receiver and extracting the transmitter only RSNR penalty by removing contributions from the reference receiver using the known parameters.

8. The method of claim 1, wherein the conducting noise loading includes virtually adding additive white Gaussian noise (AWGN) to the output signal.

9. The method of claim 1, wherein the reference receiver is one of a plurality of reference receivers, each having different capabilities or designs, and wherein the steps further include
performing the utilizing and the providing for each of the plurality of reference receivers, such that the TQM is provided for each of the plurality of reference receivers.

10. The method of claim 1, wherein the steps further include
utilizing the TQM to determine whether or not the transmitter under test complies with a specification or standard.

11. The method of claim 1, wherein the steps further include
analyzing quality of an operating link with the transmitter under test and utilizing the TQM to determine any imperfections on the operating link due to the transmitter under test.

12. A system comprising circuitry configured to:
responsive to defining a reference receiver having known parameters, conduct noise loading on an output signal from a transmitter under test,
utilize the reference receiver and a calculation to determine a transmitter only required signal-to-noise ratio (RSNR) penalty, ΔRSNRₜₓ, and
provide the ΔRSNRₜₓ as a transmitter quality metric (TQM).

13. The system of claim 12, wherein the transmitter only RSNR penalty is a difference between a RSNR to achieve a required pre-forward error correction (FEC) bit error rate (BER) and a theoretically required RSNR for an ideal modem in dB.

14. The system of claim 13, wherein the difference is due to imperfections in the transmitter under test where the imperfections are due to noise and/or modem eye closure.

15. The system of claim 12, wherein the reference receiver is utilized to determine modem eye closure (EC_{modem}) and Modem implementation noise-to-signal ratio (NSR_{modem}).

16. The system of claim 12, wherein the transmitter only RSNR penalty is extracted by determining the RSNR penalty between both the transmitter under test and the reference receiver and extracting the transmitter only RSNR penalty by removing contributions from the reference receiver using the known parameters.

17. The system of claim 12, wherein the noise loading includes virtually adding additive white Gaussian noise (AWGN) to the output signal.

18. The system of claim 12, wherein the reference receiver is one of a plurality of reference receivers, each having different capabilities or designs, and wherein the circuitry is further configured to utilize each of the plurality of reference receivers, such that the TQM is provided for each of the plurality of reference receivers.

19. The system of claim 12, wherein the circuitry is further configured to
utilize the TQM to determine whether or not the transmitter under test complies with a specification or standard.

20. The system of claim 12, wherein the circuitry is further configured to
analyze quality of an operating link with the transmitter under test and utilizing the TQM to determine any imperfections on the operating link due to the transmitter under test.
